(19) United States
(12) Patent Application Publication
(10) Pub. No.: US 2014/0100743 A1
(43) Pub. Date: Apr. 10, 2014

(54) TRAVEL SPEED CONTROL SYSTEM FOR WORK VEHICLE

(71) Applicant: CNH AMERICA LLC, New Holland, PA (US)

(72) Inventors: Christopher A. FOSTER, Denver, PA (US); Richard P. STROSSER, Akron, PA (US); Nathan C. GROTELUESCHEN, Spicer, MN (US); David G. LUTZ, New Holland, PA (US)

(73) Assignee: CNH AMERICA LLC, New Holland, PA (US)

(21) Appl. No.: 13/644,757

(22) Filed: Oct. 4, 2012

(51) Int. Cl. G06F 17/00

(52) U.S. Cl. 701/50

(57) ABSTRACT

A travel speed control system for a work vehicle including a control device configured to control travel speed of a work vehicle operable in a first travel mode and in a second travel mode. The work vehicle is movable between a first travel direction and an opposed second travel direction in each of the first travel mode and the second travel mode. The first travel mode is configured to control acceleration of the work vehicle relative to an amount of force or movement of the control device. The second travel mode is configured to control speed of the work vehicle relative to an amount of force or movement of the control device.

### FIELD OF THE INVENTION

The present invention relates generally to the field of work vehicles. It relates more particularly to travel speed control of work vehicles.

### BACKGROUND OF THE INVENTION

Working vehicles, such as harvesters, primarily operate in an operating mode that facilitates ever-increasing travel speeds, similarly corresponding to increasing grain processing speeds during operation in the open field. While this operating mode is consistent with and generally works well during high rates of productions, it is not well suited for other operating modes requiring greater control, such as installing/removing attachments, such as headers. Additionally, conventional work vehicles having multiple operating modes are limited by the travel direction of the work vehicle. That is, the work vehicle may have one operating mode in a forward direction and a different operating mode in a reverse direction, which is often insufficient to accommodate work vehicle operator needs.

Accordingly, it would be desirable to permit easy selectable operation mode switching by an operator in either forward or reverse travel directions of the work vehicle.

### SUMMARY OF THE INVENTION

The present invention relates to a travel speed control system for a work vehicle including a control device configured to control travel speed of a work vehicle operable in a first travel mode and in a second travel mode. The work vehicle is movable between a first travel direction and an opposed second travel direction in each of the first travel mode and the second travel mode. The first travel mode is configured to control acceleration of the work vehicle relative to an amount of force or movement of the control device. The second travel mode is configured to control speed of the work vehicle relative to an amount of force or movement of the control device.

The present invention further relates to a work vehicle including a travel speed control system including a control device configured to control travel speed of a work vehicle operable in a first travel mode and in a second travel mode. The work vehicle is movable between a first travel direction and an opposed second travel direction in each of the first travel mode and the second travel mode. A mode selection article selectably shifts between the first mode and the second mode. The first travel mode is configured to control acceleration of the work vehicle relative to an amount of force or movement of the control device. The second travel mode is configured to control speed of the work vehicle relative to an amount of force or movement of the control device.

The present invention further relates to a method for controlling a travel speed of a work vehicle including providing a control device configured to control travel speed of a work vehicle operable in a first travel mode and in a second travel mode. The work vehicle is movable between a first travel direction and an opposed second travel direction in each of the first travel mode and the second travel mode. The first travel mode is configured to control acceleration of the work vehicle relative to an amount of force or movement of the control device. The second travel mode is configured to control speed of the work vehicle relative to an amount of force or movement of the control device. The method further includes selectably shifting between the first mode and the second mode.

An advantage of the present invention is the capability to selectably switch between operating modes of a work vehicle, irrespective the travel direction of the work vehicle.

Another advantage of the present invention is the capability to selectably switch between operating modes based on the operation the work vehicle is performing (e.g., harvesting in field versus attaching a header).

Embodiments of the present invention will have one or more of the above advantages.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a side view of an embodiment of a control device for use with a travel speed control system of the present disclosure.

FIGS. 2-3 show in graphical form a first work vehicle operating mode usable with a travel speed control system of the present disclosure.

FIGS. 4-5 show in graphical form a second work vehicle operating mode usable with a travel speed control system of the present disclosure.

FIG. 6 shows schematically an exemplary embodiment of a travel speed control system of the present disclosure.

Wherever possible, the same reference numbers will be used throughout the drawings to refer to the same or like parts.

### DETAILED DESCRIPTION OF THE INVENTION

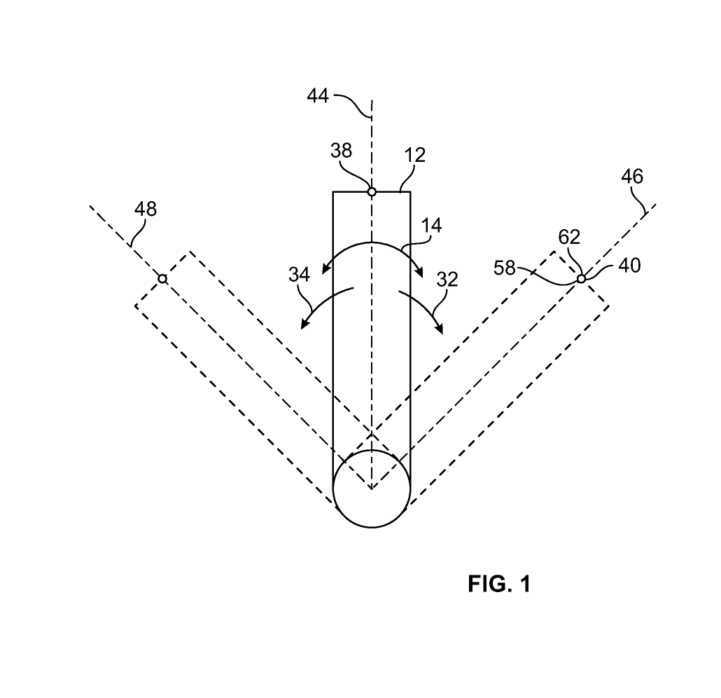

Referring to the drawings, FIG. 1 shows a control device 12, such as a control handle for use with a travel speed control system 10 of the present disclosure. It is to be understood that control device 12, as shown in FIG. 1 in an exemplary embodiment may be a lever that is operated by an operator to control the travel speed of the work vehicle relative to an amount of force or movement of control device 12. In one embodiment, movement of control device 12 includes a deflection 14 from a predetermined position, such as angular deflection from an axis 44 corresponding to a neutral position 38.

However, in another embodiment, for example, the control device may be a device configured for use with a torsion spring, or for example, in yet another embodiment, the control device may be a slidable switch or object easily grasped and manipulated by an operator.

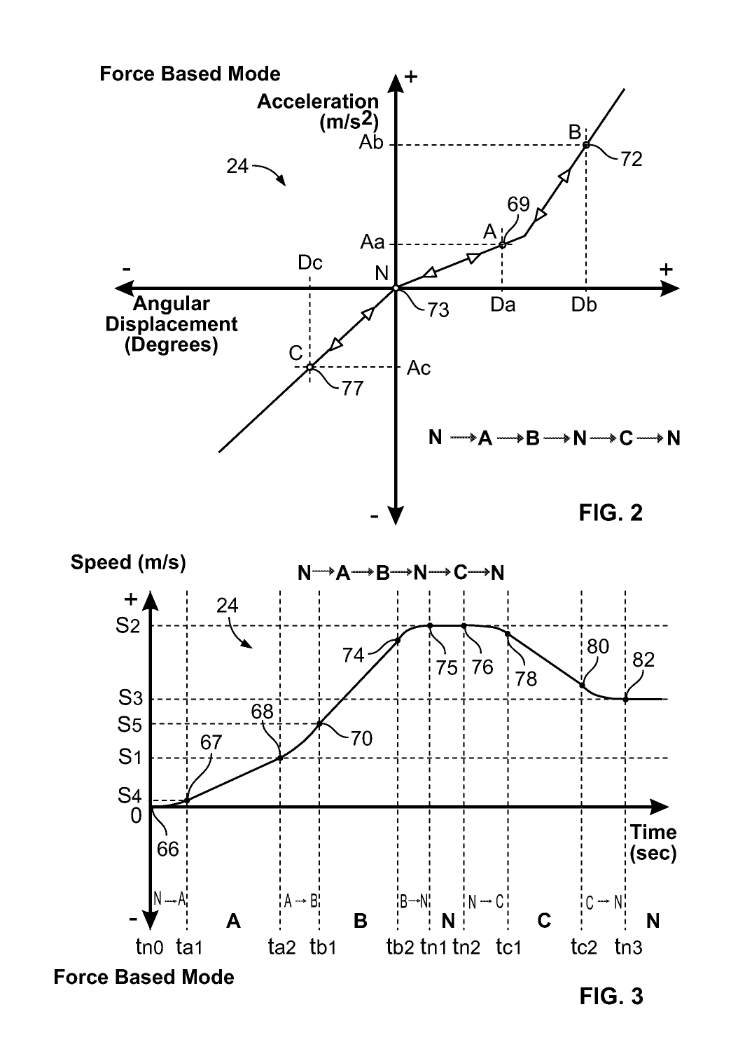

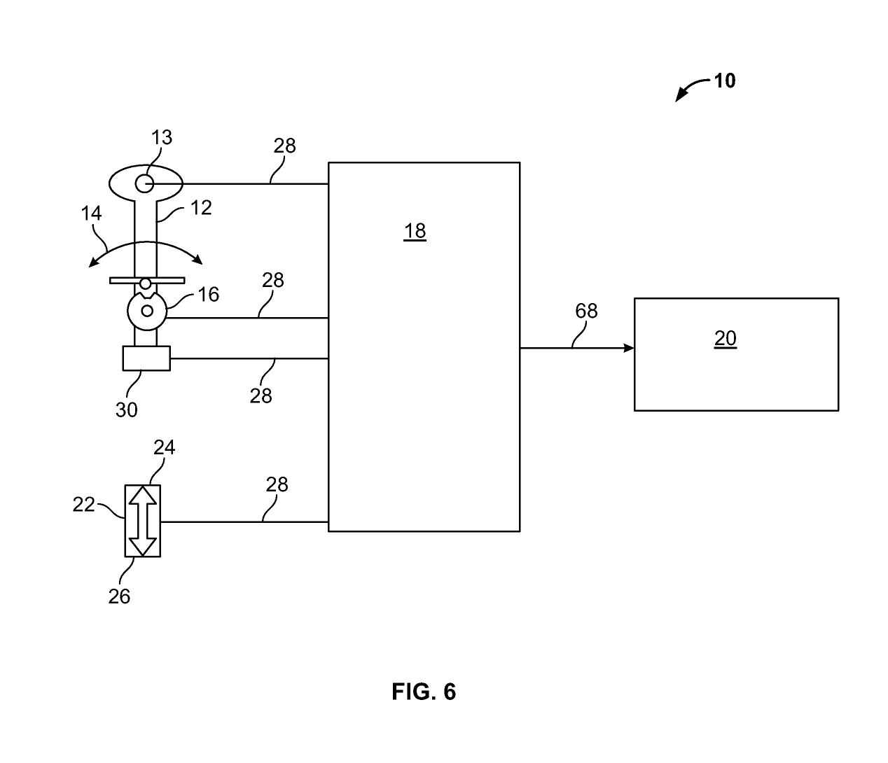

As shown in FIGS. 2-3, a first travel mode 24 or first travel mode position or similar description for a travel mode usable with travel speed control system 10 (FIG. 6) is now discussed. FIG. 2 shows the relationship between acceleration (m/s²) of a work vehicle (Y-axis) in response to angular deflections (degrees) of the control device. FIG. 3 shows the relationship between speed (m/s) of a work vehicle (Y-axis) in response to durations of time (sec) corresponding to the angular deflections of the control device. As shown in FIGS. 2 and 3, the control device is moved between positions N→A→B→N→C→N. For example, “N” position corresponds to a neutral position of the control device, such as coincident with axis 44 of control device 12 (FIG. 1), with “A” and “B” positions corresponding to an angular deflection or displacement in one direction, such as from axis 44 toward axis 46 (FIG. 1). Conversely, “C” position corresponds to an angular deflection or displacement in a direction opposite that to reach the “A” or “B” positions, such as from axis 44 toward axis 48 (FIG. 1). In another embodiment, the figures could be representative of respective work vehicle accelerations and velocities relative to an amount of force applied to the control device.

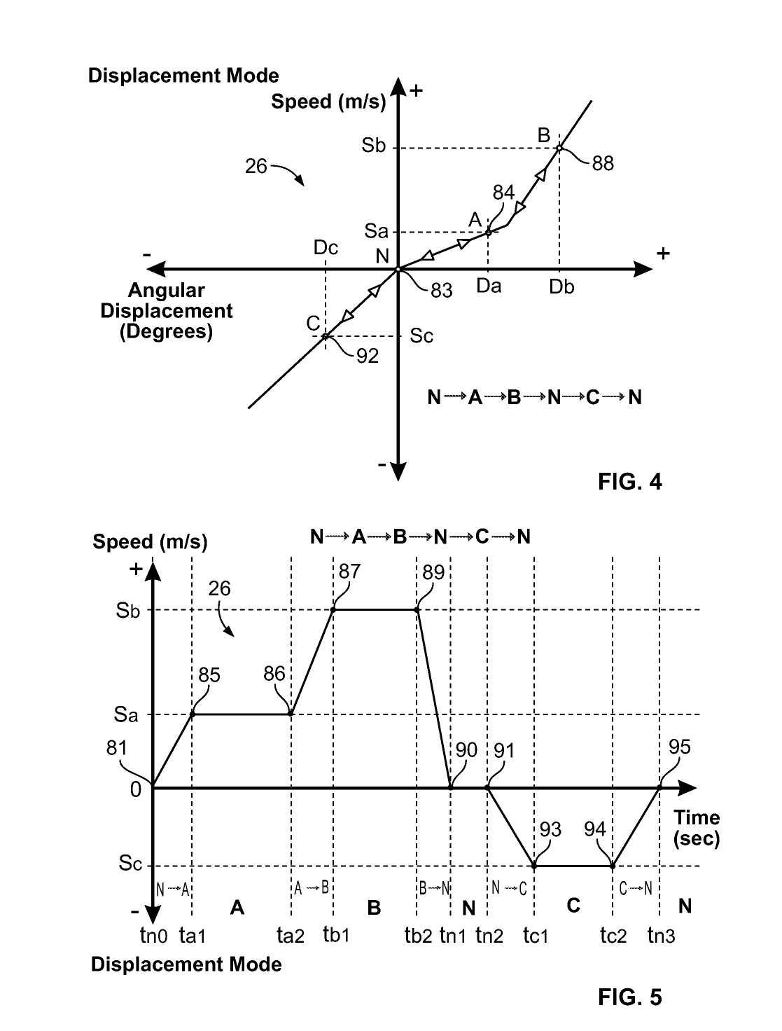

To permit a comparison between first travel mode 24 (FIGS. 2-3) and a second travel mode 26 (FIGS. 4-5), not only will the control device have the same movement patterns (i.e., N→A→B→N→C→N; see FIGS. 2 and 4 previously discussed), but the time duration the control device is maintained at each position is also the same (see FIGS. 3 and 5). As shown in the drawings, a basic distinction exists between first travel mode 24 and second travel mode 26. For example, with first travel mode 24, the acceleration of the work vehicle is controlled in response to deflection of the control device. Conversely, with second travel mode 26, the speed of the work vehicle is controlled in response to deflection of the control device.

As further shown in interrelated FIGS. 2-3, in first travel mode 24, the time (sec) required to move the control device from position N to position A (tₙₒ to tₐ₁) (from point 66 to point 67, FIG. 3) corresponds to an increase in acceleration (m/s²) from zero to Aa (from point 73 to point 69, FIG. 2), and also corresponds to an increase in speed from zero to about S4 (from point 66 to point 67, FIG. 3). Maintaining control device in position A between a time period (tₐ₁ to tₐ₂, FIG. 3) (sec) corresponds to the work vehicle acceleration (m/s²), maintaining to Aa and speed (m/s) increasing from about S4 to S1 (from point 67 to point 68, FIG. 3). In first travel mode 24, maintaining the control device in a non-neutral position corresponds to non-zero acceleration, as well as changing velocity, if the orientation of the control device coincides with the speed and acceleration of the work vehicle. For example, movement of the control device from position A to B in a time period (tₐ₂ to t_{b1}) (sec) results in an increase of acceleration (m/s²) from Aa to Ab (from point 69 to point 72, FIG. 2) as well as an increase in speed (m/s) from S1 to approximately S5 (from point 68 to point 70, FIG. 3).

As further shown in FIGS. 2 and 3, maintaining control device in position B during a time period (t_{b1} to t_{b2}, FIG. 3) (sec) corresponds to maintaining acceleration (m/s²) of work vehicle at Ab (point 72, FIG. 2), and an increase in speed (m/s) from point 70 to point 74 (FIG. 3). Moving the control device from position B to position N during a time period (t_{b2} to tₐ₁) FIG. 3) (sec) corresponds to a decrease in acceleration (m/s²) from Ab to zero (from point 72 to point 73, FIG. 2). Maintaining the control device at N for a time period (tₙ₁ to tₙ₂, FIG. 3) (sec) corresponds to maintaining speed at S2 (points 75 to 76, FIG. 3). That is, in first travel mode 24, moving control device to neutral position N maintains the work vehicle at a substantially constant speed.

As shown in FIGS. 2 and 3, further movement of the control device from position N to position C during a time period (tₙ₂ to t_{c1}) (sec) corresponds to a decrease in acceleration (m/s²) from zero to (−)Ac (from point 73 to point 77, FIG. 2). Maintaining the control device at C for a time period (t_{c1} to t_{c2}) (sec) corresponds to a decrease in speed (m/s) from point 78 (FIG. 3), to point 80 (FIG. 3). Further shown in FIGS. 2 and 3, further movement of the control device from position C to position N during a time period (t_{c2} to tₙ₃, FIG. 3) (sec) corresponds to an increase in acceleration from (−)Ac to zero (from point 77 to point 73, FIG. 2). Maintaining the control device at N (greater than tₙ₃) (sec), corresponds to the speed of the working vehicle then holding at point 82 (S3, FIG. 3).

As further shown in FIGS. 4 and 5, in second travel mode 26, the time (sec) required to move the control device from position N to position A during a time period (tₙₒ to tₐ₁, FIG. 5) (sec) corresponds to an increase in speed (m/s) from zero (point 83, FIG. 4; point 81, FIG. 5) to Sa (point 84, FIG. 4; point 85, FIG. 5). Maintaining control device in position A during a time period (tₐ₁ to tₐ₂, FIG. 5) (sec) corresponds to a constant work vehicle speed of Sa (from point 85 to point 86, FIG. 5). In second travel mode 26, maintaining the control device in a non-neutral position corresponds to a constant speed (increasing to the particular speed if the orientation of the control device coincides with the direction of travel of the work vehicle; decreasing to the particular speed if the orientation of the control device is opposite of the travel direction of the work vehicle. For example, movement of the control device from position A to B during a time period (tₐ₂ to t_{b1}, FIG. 5) (sec) results in an increase of speed (m/s) from Sa (point 84, FIG. 4; point 86, FIG. 5) to Sb (point 88, FIG. 4; point 87, FIG. 5).

As shown in FIGS. 4 and 5, maintaining control device in position B during a time period (t_{b1} to t_{b2}, FIG. 5) (sec) corresponds to a constant speed (m/s) of work vehicle at Sb (from point 87 to point 89, FIG. 5). Moving the control device from position B to position N during a time period (t_{b2} to tₙ₁, FIG. 5) (sec) corresponds to a decrease in work vehicle speed (m/s) from Sb (point 88, FIG. 4; point 89, FIG. 5) to zero (point 83, FIG. 4; point 90, FIG. 5). Maintaining the control device at N for a time period (tₙ₁ to tₙ₂, FIG. 5) (sec) maintains the work vehicle speed at zero. That is, in second travel mode 26, moving control device to neutral position N reduces work vehicle speed to zero.

As shown in FIGS. 4 and 5, further movement of the control device from position N to position C during a time period (tₙ₂ to t_{c1}, FIG. 5) (sec) corresponds to an increase in work vehicle speed (m/s) from zero (point 83, FIG. 4; point 91, FIG. 5) to (−) Sc (92, FIG. 4; point 93, FIG. 5). Since speed is an absolute value, the use of (−) in FIG. 5 indicates travel in a direction opposite to the direction of travel for values shown above the zero speed line in FIG. 5. Maintaining the control device at C for a time period (t_{c1} to t_{c2}, FIG. 5) (sec) maintains the work vehicle speed at Sc in a direction opposite the travel direction for values above the zero speed line in FIG. 5. As further shown in FIGS. 4 and 5, further movement of the control device from position C to position N during a time period (t_{c2} to tₙ₃, FIG. 5) (sec) corresponds to a decrease in vehicle speed from (−) Sc (point 92, FIG. 4; point 94, FIG. 5) to zero (point 83, FIG. 4; point 95, FIG. 5). Maintaining the control device at N during a time period (greater than tₙ₃) (sec) maintains the speed of the working vehicle at zero.

The speeds of first travel mode 24 and second travel mode 26 are not compared directly with each other, since adjustments can be made such that the velocity magnitudes of either mode could be less than, equal to, or greater than the velocity magnitude of the other mode. Similarly, accelerations of first travel mode 24 and second travel mode 26 are not compared directly with each other, since adjustments can be made such that the velocity magnitudes of either mode could be less than, equal to, or greater than the velocity magnitude of the other mode.

A discussion of comparative relative speeds and accelerations between first travel mode 24 and second travel mode 26 is now discussed. For example, in one embodiment, both the maximum speed and acceleration of a work vehicle in first travel mode 24 is greater than the maximum speed and acceleration of a work vehicle in second travel mode 26. Additionally, in the same or a different embodiment, both the maximum speed and acceleration of the work vehicle in first travel mode 24 in a first direction, such as forward, is greater than the maximum speed and acceleration of the work vehicle in the first travel mode 24 in a second direction, such as reverse. Further, in the same or a different embodiment, both the maximum speed and acceleration of the work vehicle in second travel mode 26 in a first direction, such as forward, is greater than the maximum speed and acceleration of the work vehicle in the second travel mode 26 in a second correction, such as reverse.

Applying the above relationships between first travel mode 24 and second travel mode 26 and further between forward and reverse travel directions in each of first travel mode 24 and second travel mode 26 yields the following results in the exemplary embodiment. That is, if a range of speed of the work vehicle in first travel mode 24 is from zero to maximum speed of the work vehicle, the range of speed of the work vehicle in second travel mode 26 is from zero to a percentage (i.e., a proper fraction) of maximum speed of the work vehicle. In addition, if the range of speed of the work vehicle in first travel mode 24 in the first travel direction (forward) is from zero to maximum speed, the range of speed of the work vehicle in first travel mode 24 in the second travel direction (reverse) is from zero to a percentage (i.e., a proper fraction) of maximum speed. Further, the range of speed of the work vehicle in the second travel mode of from zero to a percentage (i.e., a proper fraction) of maximum speed is less than the range of speed in the first travel mode. Stated differently, the maximum travel speed in the second travel mode is less than a maximum travel speed in the first travel mode. In addition, the range of speed of the work vehicle in second travel mode 26 in the first direction (forward) of from zero to a percentage (i.e., a proper fraction) of maximum speed is greater than the range of speed in second travel mode 26 in the second direction (reverse). Stated another way, the maximum travel speed in the second travel mode in the first direction (forward) is greater than a maximum travel speed in the second travel mode in a second direction (reverse).

Similarly for acceleration, if a range of acceleration of the work vehicle in first travel mode 24 is from zero to maximum acceleration, the range of acceleration of the work vehicle in first travel mode 24 in the first travel direction (forward) is from zero to maximum acceleration, and the range of acceleration of the work vehicle in first travel mode 24 in the second travel direction (reverse) is from zero to a percentage (i.e., a proper fraction) of maximum acceleration. In addition, if the range of acceleration of the work vehicle in second travel mode 26 of from zero to a percentage (i.e., a proper fraction) of maximum acceleration, the range of acceleration of the work vehicle in second travel mode 26 of from zero to a percentage (i.e., a proper fraction) of maximum acceleration is less than the range of acceleration in first travel mode 24. That is, a maximum travel acceleration in the second travel mode is less than a maximum travel acceleration in the first travel mode. Finally, the range of acceleration of the work vehicle in second travel mode 26 in the first direction (forward) of from zero to a percentage (i.e., a proper fraction) of maximum acceleration is greater than the range of acceleration in second travel mode 26 in the second direction (reverse). Stated another way, the maximum travel acceleration in the second travel mode in the first direction (forward) is greater than a maximum travel acceleration in the second travel mode in a second direction (reverse).

In this embodiment, first travel mode 24 facilitates ease of work vehicle operation, especially at high ground speeds, due to the ability of the operator to reach a desired speed and then release the control device, thus maintaining the constant ground speed. However, due to inertia, and other effects, the first travel mode 24 provides less precision control of the work vehicle than the first travel mode 24 (FIG. 2).

Second travel mode 26 permits more precise control of the work vehicle, including facilitating fine adjustments of the work vehicle, such as required during installation/removal of work vehicle attachments. In one embodiment, the maximum speed of the work vehicle is about 1 mph.

As shown FIG. 6, travel speed control system 10 is shown schematically and further discussed. Travel speed control system 10 includes control device 12, such as a lever, which lever having a pivot permitting angular deflection 14 of the lever about an axis of the control device. In one embodiment, a sensor 16 such as a rotary potentiometer is in electrical communication 28 with a controller 18 to determine the angular deflection 14 of control device 12 in a well-known manner. Controller 18 may be microprocessor controlled as is well-known. As previously discussed, angular deflection of control device 12 in one direction corresponds to work vehicle travel in one direction, such as a forward direction, while angular deflection of the control device in the other direction corresponds to work vehicle travel in an opposite direction, such as a reverse or backwards direction. Control device 12 may include an interlock 13, such as a button or other operator movable feature in electrical communication 28 with controller 18. Control device 12 may also include a neutral switch 30 in electrical communication 28 with controller 18 and indicates a neutral position of the control device 12. As further shown in FIG. 6, control system 10 includes a mode selection article 22, such as a switch or other component including a first mode position or first travel mode 24 and a second mode position or second travel mode 26. For example, in one arrangement of control system 10, selective operator actuation of interlock 13 and actuation of mode selection article 22 toward a first mode position or first travel mode 24 or a second mode position or second travel mode 26 results in the work vehicle being placed into the correspondingly selected mode (i.e., first mode position 24 or second mode position 26). In response to electrical communication 28 with control device 12 and mode selection article 22, controller 18, which is also in electrical communication 28 with a drive train actuator 20 controls both direction and magnitude of travel speed of a work vehicle.

In one embodiment, mode selection occurs automatically in response to satisfaction or meeting an operating parameter. For example, the operating parameter may include the work vehicle operating below a predetermined ground speed for a predetermined time duration. In another embodiment, the work vehicle may be required to be stopped. In a further embodiment, the operating parameter may include operation of the work vehicle at a hydraulic flotation pressure supporting an attachment, such as a header to a pressure that is less than a predetermined value. In one embodiment, the hydraulic flotation pressure may be required to be reduced to zero, in which case the header would be supported by the ground, in preparation of removal of the header. Further discussion of header floatation is contained in Applicant's U.S. Pat. No. 7,707,811 titled HEADER FLOATATION AND LIFT SYSTEM WITH DUAL MODE OPERATION FOR A PLANT CUTTING MACHINE which is hereby incorporated by reference in its entirety. Upon sufficient reduction of the hydraulic floatation pressure, the operator may be notified by a message displayed on a display viewable by the operator, such as “ENTERING HEADER REMOVAL MODE” or the like, which may also be accompanied by one or more audio warnings. Conversely, upon engaging an attachment for use, and the hydraulic floatation pressure being sufficiently increased to a value greater than a predetermined value, the operator may be notified by a message displayed on a display viewable by the operator, such as “EXITING HEADER REMOVAL MODE” or the like, which may also be accompanied by one or more audio warnings. Upon resumption of normal operations, the displayed message relating to header removal mode would be removed from the display. In another embodiment, mode selection may occur as a result of selecting a displayed image of the mode selector switch or the like on a display associated with operation of the work vehicle.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A travel speed control system for a work vehicle comprising:
a control device configured to control travel speed of a work vehicle and being selectively operable in one of a first travel mode and in a second travel mode, the work vehicle movable between a first travel direction and an opposed second travel direction in each of the first travel mode and the second travel mode;
wherein the first travel mode is configured to control acceleration of the work vehicle to a user selected magnitude in response to an amount of force or movement of the control device, and the second travel mode is con figured to control speed of the work vehicle to a user selected velocity in response to an amount of force or movement of the control device.

2. The control system of claim 1, wherein a range of speed of the work vehicle in the first travel mode is from zero to maximum speed.

3. The control system of claim 2, wherein the range of speed of the work vehicle in the first travel mode in the first travel direction is from zero to maximum speed, and the range of speed of the work vehicle in the first travel mode in the second travel direction is from zero to a percentage of maximum speed.

4. The control system of claim 1, wherein a range of speed of the work vehicle in the second travel mode is from zero to a percentage of maximum speed.

5. The control system of claim 4, wherein the range of speed of the work vehicle in the second travel mode of from zero to a percentage of maximum speed is less than the range of speed in the first travel mode.

6. The control system of claim 5, wherein the maximum speed of the work vehicle in the second travel mode is about 1 mph.

7. The control system of claim 5, wherein the range of speed of the work vehicle in the second travel mode in the first direction of from zero to a percentage of maximum speed is greater than the range of speed in the second travel mode in the second direction.

8. The control system of claim 1, wherein a range of acceleration of the work vehicle in the first travel mode is from zero to maximum acceleration.

9. The control system of claim 8, wherein the range of acceleration of the work vehicle in the first travel mode in the first travel direction is from zero to maximum acceleration, and the range of acceleration of the work vehicle in the first travel mode in the second travel direction is from zero to a percentage of maximum acceleration.

10. The control system of claim 1, wherein a range of acceleration of the work vehicle in the second travel mode is from zero to a percentage of maximum acceleration.

11. The control system of claim 10, wherein the range of acceleration of the work vehicle in the second travel mode of from zero to a percentage of maximum acceleration is less than the range of acceleration in the first travel mode.

12. The control system of claim 10, wherein the range of acceleration of the work vehicle in the second travel mode in the first direction of from zero to a percentage of maximum acceleration is greater than the range of acceleration in the second travel mode in the second direction.

13. The control system of claim 1, further including a mode selection article for selectably shifting between the first mode and the second mode.

14. The system of claim 1, wherein the control device includes a sensor to determine direction and magnitude of actuation of the control device.

15. The system of claim 1, wherein mode selection occurs automatically in response to meeting an operating parameter.

16. The system of claim 15, wherein the operating parameter includes the work vehicle operating below a predetermined ground speed for a predetermined time duration.

17. The system of claim 15, wherein the operating parameter includes operation of the work vehicle at a hydraulic floatation pressure less than a predetermined value.

18. The system of claim 15, wherein in response to meeting the operating parameter, at least one of a video display indication and an audio warning is generated.

19. A work vehicle comprising:
a travel speed control system comprising:
a control device configured to control travel speed of a work vehicle and being selectively operable in one of a first travel mode and a second travel mode, the work vehicle movable between a first travel direction and an opposed second travel direction in each of the first travel mode and the second travel mode;
a mode selection article for selectably shifting between the first travel mode and the second travel mode; and
wherein the first travel mode is configured to control acceleration of the work vehicle to a user selected magnitude in response an amount of force or movement of the control device, and the second travel mode is configured to control speed of the work vehicle to a user selected velocity in response to an amount of force or movement of the control device.

20. A method for controlling a travel speed of a work vehicle comprising:
providing; a control device configured to control travel speed of a work vehicle and being operable in one of a first travel mode and a second travel mode, the work vehicle movable between a first travel direction and an opposed second travel direction in each of the first travel mode and the second travel mode;
selectably shifting between the first travel mode and the second travel mode;
controlling acceleration of the work vehicle to a user selected magnitude in response an amount of force or movement of the control device with the control device in the first travel mode; and
controlling speed of the work vehicle to a user selected velocity in response to an amount of force or movement of the control device with the control device in the second travel mode.
